(19) United States
(12) Patent Application Publication
(10) Pub. No.: US 2007/0007879 A1
(43) Pub. Date: Jan. 11, 2007

(54) Low vapor pressure gas delivery system and apparatus

(76) Inventors: Thomas John Bergman JR., Clarence Center, NY (US); Martin Lee Timm, Getzville, NY (US); Kenneth Leroy Burgers, East Amherst, NY (US); Jessica Anne Tworek, Williamsville, NY (US); Keith Randall Pace, East Amherst, NY (US); Shrikar Chakravarti, East Amherst, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/177,291

(22) Filed: Jul. 11, 2005

(51) Int. Cl. H01J 1/62

(52) U.S. Cl. 313/493

(57) ABSTRACT

A system and apparatus for manufacturing a low vapor pressure vapor stream lean in low volatility contaminants, and delivering same to a point of use. The system provides a transport vessel having a liquid phase or two-phase fluid held therein. The liquid and/or two-phase is transferred from said transport vessel to a vaporization vessel, wherein at least part of the liquid is vaporized. A liquid stream that is enriched in low volatility contaminants is withdrawn from the vaporization vessel, and a stream that is lean in low volatility contaminants is withdrawn from the vaporization vessel. The low vapor pressure stream is delivered to a point of use and the purity is maintained within a desired range.

### BACKGROUND OF THE INVENTION

1. Field of the Invention

The present invention relates to a system and apparatus for manufacturing a low vapor pressure stream lean in low volatility contaminants. In particular, the invention relates to the formation of a vapor phase low vapor pressure gas stream from a liquid or two phase, non-air based gas source which may be delivered to a point of use such as semiconductor, light emitting diode (LED) or liquid crystal display (LCD) manufacturing tool.

2. Description of Related Art

Manufacture of semiconductor devices, LEDs and LCDs involves a number of discrete processing steps in which non-air based gases are employed. As defined herein, “non-air gases” means any gases that are not derived from air and their constituent components. Examples of such non-air gases include, but are not limited to silane, nitrogen trifluoride and ammonia.

Typically, non-air gases supplied to the semiconductor, LED or LCD manufacturer (also referred to as the ultimate user or point of use) must contain a consistent low level of contaminants, particularly those contaminants that are less volatile than the non-air gas. These contaminants include water, metals and particles. In addition, the non-air gases must be delivered to the ultimate user in vapor phase at elevated pressure (e.g., greater than 50 psig), and at highly variable flow.

Several non-air gases are transported in vapor phase from the gas producer to the ultimate user. Such non-air gases include silane and nitrogen trifluoride. Typically, non-air gas that is transported in vapor phase is able to meet the purity requirements of the ultimate manufacturer point of use since the contaminant level is stable and does not change as non-air gas is drawn from the transport vessel. In addition, the vapor need not be conditioned (e.g., vaporized, pumped, heated). The pressure requirement is met by simply supplying vapor at high pressure (e.g., greater than 1000 psig). Highly variable flow rates are accommodated by simply sizing the piping, valve, etc. under the proper circumstances. Since the vapor is not conditioned, the transport vessel or storage vessel does not need to be modified.

Other non-air gases are transported as liquid or liquid/vapor two-phase fluid from the gas manufacturer to ultimate user. Such gases are known as low vapor pressure gases and include ammonia, hydrogen chloride, carbon dioxide and dichlorosilane. Low vapor pressure gases typically have a vapor pressure of less than 1500 psig at a temperature of 70° F. Because these gases are not available in vapor phase at elevated pressure and ambient temperature, particularly intricate systems are required to deliver a vapor phase stream which meets all the requirements at the point of use.

One such system is described in U.S. Pat. No. 6,363,728 to Udischas et al., wherein a delivery vessel holds a bulk quantity of liquefied gas, and the delivery vessel has a heat exchanger disposed thereon to provide or remove energy from the liquefied gas. A pressure controller monitors the pressure and adjusts the energy delivered to vessel. The system purportedly allows for controlled delivery of vapor phase gas at a predetermined flow rate.

U.S. Pat. No. 6,581,412 discloses a method for delivering a vapor phase gas from a liquefied compressed gas storage vessel at a high rate of flow. A heating means is provided proximate to the storage vessel and a temperature measuring device is disposed onto the vessel wall. Depending on the vessel wall temperature, the energy output of the heating means is changed to heat the liquefied compressed gas therein.

U.S. Pat. No. 6,614,009 relates to a high flow rate, ultra high purity gas vaporization and supply system, wherein the storage vessel is suitable for carrying large quantities of liquefied gas. This system consists of a plurality of valves adapted to operate with liquid or gas phases, a loading/unloading unit for handling the liquefied gas and a heater containing elements that are permanently positioned on the vessel to supply energy into the liquefied gas.

The documents discussed above disclose configurations wherein low vapor pressure gas is, withdrawn form a heated liquid transport/storage vessel. The contaminants that have a lower volatility than the low vapor pressure gas remain in the liquid phase, producing a vapor that is lean in low volatility contaminants. However, as the vapor is drawn from the vessel, the low volatility contaminant level builds in both the liquid and vapor phases. When a certain level of low volatility contaminant level is reached in the vapor phase, the vapor withdrawal is discontinued. The remaining liquid, sometimes referred to as “heel”, is enriched in contaminants that are less volatile than low vapor pressure gas. This “heel” is subsequently discarded.

As an example, liquid ammonia supplied to customer sites contains some water, typically at a concentration ranging from 0.5 to 10 ppm. This moisture level is often unacceptable to the ultimate manufacturer, who typically requires moisture levels ranging from 1 ppb to 0.2 ppm. As vapor ammonia is drawn from this supply system, the water level in the remaining liquid phase increases. The water level associated with the final “heel” typically ranges from 50-1000 ppm.

One of the disadvantages associated with the systems described is that since liquefied gas is transported, stored and vaporized in the same vessel, the vessel surface area available to accommodate heaters is limited. Therefore, the maximum draw rate that can be achieved is limited.

A further disadvantage is that these systems do not provide a stable product purity, since the low volatility contaminant level in the vapor stream increases as the amount of liquid in the vessel decreases.

U.S. Pat. No. 6,637,212 to Torres, Jr. et al., describes a system and process for delivering a vapor phase product having a constant impurity level from a liquefied gas source to an end point. The system includes, inter alia, a vaporizing means for converting the liquefied gas having a concentration of soluble impurities to the vapor phase, and a heating means to completely vaporize the liquefied gas, where the level of impurities in the vapor phase product is substantially equivalent to the level in the liquefied gas.

U.S. Pat. No. 5,894,742 to Friedt pertains to a method and system to deliver ultra-pure gases which are liquefied at room temperature with a vapor pressure above atmospheric pressure to semiconductor tools and other points of use.

U.S. Pat. No. 5,690,743 to Murakami et al relates to an apparatus for supplying a low vapor pressure liquid material for deposition in which the low vapor pressure liquid material is pushed out of a pressurization passage by a pressurized gas to a pressure liquid supply system.

One of the disadvantages related to the systems of the latter described documents is that they do not provide a mechanism for removing contaminants that have a lower volatility than the low vapor pressure gas. These contaminants are withdrawn from the transport/storage means along with the low vapor pressure gas and are delivered to the ultimate manufacturer.

To meet the requirements of the ultimate manufacturer and to overcome the disadvantages of the related art, it is an object of the present invention to provide a vapor phase non-air gas from a liquefied compressed gas source at a high volume and highly variable flow.

It is another object of the invention to provide a vapor phase non-air gas that contains a lower level of low volatility contaminants than the source liquefied compressed gas.

It is a further object of the invention to provide a vapor phase non-air gas having purity stability (i.e., approximately constant contaminant type and level).

It is yet another object of the invention to provide a liquefied non-air gas in a transport vessel that does not need to be modified in order to vaporize this gas, facilitating transport vessel changeout.

Other objects and aspects of the present invention will become apparent to one of ordinary skill in the art upon review of the specification, drawings and claims appended hereto.

### SUMMARY OF THE INVENTION

According to a first aspect of the invention, a system for manufacturing a low vapor pressure vapor stream is provided. The vapor stream is lean in low volatility contaminants and is delivered to a point of use. The system provides a transport vessel having a liquid or two-phase fluid held therein. The liquid and/or two-phase fluid is transferred from the transport vessel to a vaporization vessel, wherein at least part of the liquid is vaporized. A liquid stream that is enriched in low volatility contaminants is withdrawn from the vaporization vessel, and a low vapor pressure vapor stream that is lean in low volatility contaminants is withdrawn from the vaporization vessel and delivered to a point of use. The purity of the low vapor pressure vapor stream is maintained withinadesired range.

According to another aspect of the invention, an apparatus is provided for manufacturing a low vapor pressure vapor stream, which is lean in low volatility contaminants. The apparatus includes a transport vessel having a liquid or two-phase fluid therein, and a vaporization vessel, to which the liquid or two-phase fluid is transferred and at least partially vaporized. The vaporization vessel includes means for controlling the energy delivered thereto. A first conduit is connected to a lower part of the vaporization vessel through which a liquid stream enriched in low volatility contaminants is withdrawn. A delivery panel is connected via a second conduit to an upper part of the vaporization vessel through which a low vapor pressure vapor stream is withdrawn and routed to a point of use, wherein the purity of the low vapor pressure vapor is maintained within a desired range.

### BRIEF DESCRIPTION OF THE FIGURES

The objects and advantages of the invention will be better understood from the following detailed description of the preferred embodiments thereof in connection with the accompanying figures wherein like numbers denote same features throughout and wherein:

FIG. 1 illustrates a schematic flow diagram of a system for the manufacturing a low vapor pressure vapor stream that is lean in low volatility contaminants and which is delivered to a point of use; and

FIG. 2 depicts a schematic diagram of another embodiment of the system for the manufacture and delivery of low vapor pressure vapor stream which includes a low vapor pressure fluid recycle loop.

### DETAILED DESCRIPTION OF THE INVENTION

The manufacture of semiconductor devices, LEDs and LCDs requires the delivery of vapor phase, low vapor pressure gases to a point of use. These gases must meet customer purity and flow requirements. The present invention provides a means to transport a compressed, liquefied low vapor pressure gas from the gas manufacturer, and process this non-air gas so as to deliver a low vapor pressure vapor stream which is lean in low volatility contaminants to the point of use. As utilized herein, the term “lean” shall mean a vapor stream having a lower level of low volatility contaminants therein than the liquid or two-phase fluid provided by the gas manufacturer. The system provides the requisite purity on a consistent basis and maintains stable purity levels in the embodiments. Further, the supply vessel (referred below, as the transport vessel) does not require modification to vaporize the liquefied gas since the transport and vaporization functions are performed in distinct vessels. In addition, the system is highly modular, allowing for simple cost effective capacity expansion.

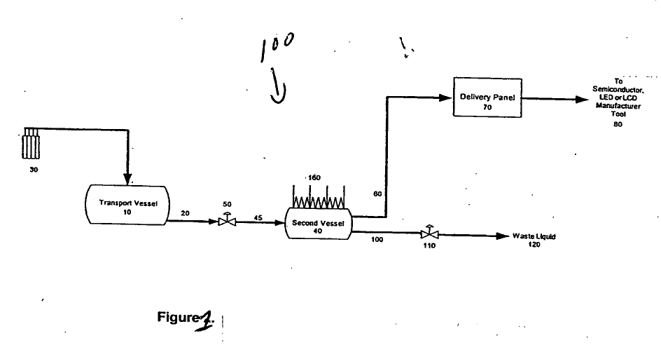

With reference to FIG. 1, one of the embodiments of the invention is described, which illustrates the transfer of ammonia from liquid storage to an LED processing tool in accordance with one exemplary aspect of the invention. Although the embodiments described herein are with respect to the use of ammonia, it will be understood by those skilled in the art that any non-air gas transported as liquid or two-phase vapor/liquid fluid may be employed.

Some LED processing tools require a high-purity ammonia vapor stream for depositing an epitaxial layer of gallium nitride on a sapphire substrate. In the processing tool, vapor ammonia reacts with a gallium source such as trimethylgallium, in the presence of the substrate to form and immediately deposit gallium nitride. A group of several such processing tools may require, on average, 1000 slpm (standard liters per minute) of ammonia vapor at a pressure of 50 psig and ambient temperatures. The actual ammonia use rate at the tool may be highly variable, ranging from 0 slpm to more than 2000 slpm. To meet the average ammonia requirement, a large transport vessel capable of holding, for example, 23,000 gallons of liquid ammonia, may be required.

Referring to FIG. 1, a system 100 is provided, preferably indoors or within an enclosure (not shown) that allows operation at ambient temperatures. Ammonia is transported from the non-air gas manufacturer to the ultimate user in a transport vessel 10, such as an isotainer. The transport vessel is in fluid communication with a vaporization vessel 40 via conduit 20. Ammonia transfer from the transport vessel to the vaporization vessel may be facilitated by pressurizing the transport vessel through injection of a high pressure, inert gas into the transport vessel 10. For example, pressurization can be accomplished by providing gaseous helium from a helium supply system 30 to transport vessel 10. The inert gas is typically supplied in cylinders at a pressure between about 2000 psig and 6000 psig, so as to maintain a pressure level between about 100 psig and 350 psig in transport vessel 10. If inert gas injection is, however, undesirable due to purity concerns, transport vessel 10 may be pressurized by providing energy to transport vessel 10, utilizing a heating blanket, or any other suitable heating devices. Further, a pump can be utilized to transfer liquid from the transport vessel to the vaporization vessel.

Ammonia may be transferred from transport vessel 10 to the vaporization vessel batchwise or in semi-continuous fashion. In batchwise transfer, liquid or two phase ammonia is transferred from the transport vessel to the vaporization vessel 40 until the desired ammonia volume is attained in the vaporization vessel 40. Vapor ammonia is then drawn from the vaporization vessel 40 until the liquid level falls to a predetermined value (i.e., until a certain “heel” volume remains). When this “heel” volume is attained, the “heel” is discarded and the vaporization vessel 40 is refilled from transport vessel 10.

Alternatively, ammonia may flow from the transport vessel 10 to the vaporization vessel 40 in semi-continuous fashion. In this embodiment, flow from the transport vessel 10 to the vaporization vessel 40 is controlled by a control valve 50 disposed on conduit 20, such that the liquid level in vaporization vessel is maintained at a relatively constant value. Liquid level in the second containment vessel 20 is typically maintained in the range of about 1%-95% of the vessel height. The liquid level is selected to optimize the balance between liquid entrainment in the vapor phase stream and liquid contact with the heated vessel inner surface. The streams entering and leaving control valve 50 via conduit 45 may be liquid or two phase. Preferably, the stream upstream of the control valve is liquid phase.

Alternatively, the liquid stream withdrawn from transport vessel 10 can be treated to prevent it from becoming a two phase mixture prior to its introduction into vaporization vessel 40. This may be desirable to prevent the vapor stream exiting from the vaporization vessel from carrying liquid droplets. These liquid droplets could carry contaminants that are less volatile than ammonia, which would have a deleterious effect on the ammonia purity. Such treatment means include subcooling the liquid stream withdrawn from transport vessel 10, either through a heat exchanger or through pressurization, and routing the liquid stream to a separator (not shown) disposed upstream of the vaporization vessel.

In the vaporization vessel 40, vapor and liquid phase ammonia and contaminants exist at or near equilibrium. Contaminants that are less volatile than the low vapor pressure gas, such as water, metals, and particulates, preferentially remain in liquid phase, while ammonia preferentially remains in the vapor phase. Therefore, the low volatility contaminant content of the vapor stream 60 exiting the vaporization vessel 40 is lower than in the liquid or two phase stream 45 entering the vaporization vessel 20. For example, if the vaporization vessel 40 operates in semi-continuous fashion at a pressure of 100 psig and a liquid level such that 75 percent of the tank contents on a molar basis is in the liquid phase, and the two phase stream entering the vaporization vessel were to have a water content of 1 part per million (ppm) on a molar basis, the water content of vapor drawn from the vaporization vessel would be approximately 10 ppb.

The vaporization vessel includes a means for vaporizing the low vapor pressure fluid transferred therein. As the vapor stream is withdrawn from vaporization vessel 40, the pressure therein begins to diminish. To counteract this effect, and maintain the pressure within an operative range, the liquid ammonia in this vessel is partially vaporized using heater 160. Typically the pressure in the vaporization vessel is maintained in a range of 50 psig to 300 psig. The corresponding temperature ranges from about 32° F. to 125° F.

The vaporization means may include a conventional heat exchanger, such as a shell and tube exchanger, in which liquid low vapor pressure fluid is boiled against a second fluid. Alternatively, the vessel may be heated using a heater located on the surface of the vessel or within the vessel. A variety of heaters can be used. These include resistance heaters, such as a heating blanket, heating rod, or heating blanks as described in U.S. Pat. No. 6,363,728 and incorporated herein by reference in its entirety. Further examples of heaters include radiative and inductive heaters as well as microwave based heaters, as described in U.S. Patent Application Publication No. 2004/0035533.

The vapor gas space in the vaporization vessel could be superheated and circulated to vaporize the liquid contained in this vessel, eliminating the need for vessel based heaters and eliminating the potential for droplet formation. In this embodiment, vapor would be drawn from the vaporization vessel and heated by, for example, 10 to 100° F. and returned to the vessel using a blower (not shown).

In order to facilitate and/or increase the thermal exchange in the vaporization vessel, the inner surface of the vessel can be machined to increase the fluid to surface contact area, or alternatively a grooved liner material that is fastened to the interior of the vessel could be provided to increase surface area. As a result, with a greater percentage of the heated wall in contact with the liquid ammonia, the vessel can be operated at a greater vaporization capacity at a given wall temperature. Alternatively, the wall temperature can be reduced if the capacity is to be maintained constant.

The vapor stream in conduit 60, is conveyed to delivery panel 70 upstream to the point of use, which controls and regulates the flow, pressure and temperature at which the low vapor pressure vapor stream is delivered to the point of use at the desired flow rate. Generally, the flow rate ranges from about 10 slpm to 2000 slpm.

To maintain the desired contaminant level in the vapor stream withdrawn and conveyed through conduit 60, a liquid stream that is enriched in low volatile contaminants can be withdrawn from the vaporization vessel via conduit 100, to a purity control valve 110. The flow associated with the liquid stream varies depending on the purity of the liquid in the vaporization vessel and typically ranges between 0 and 90 percent of the liquid or two phase fluid flow rate to the vaporization vessel. Since an approximately constant liquid level is maintained in the vaporization vessel, the contaminant level associated with the gas stream containing primarily vapor remains constant, meeting the semiconductor, LED and LCD manufacturers requirement for a constant purity.

The level of contaminants in the low vapor pressure vapor stream can be measured and controlled by adjusting the rate at which liquid is withdrawn from the vaporization vessel 40. Preferably, liquid is withdrawn such that the ratio of liquid flow to low vapor pressure vapor flow is fixed. The ratio of liquid flow to vapor flow typically ranges from 0:1 to 2:1.

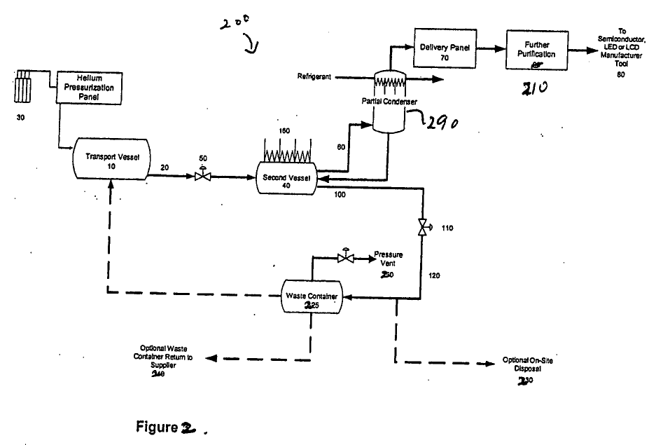

With reference to FIG. 2, another embodiment is illustrated. In this system 200, the liquid stream enriched in low volatility contaminants is routed to a waste container/vessel 225. The pressure in waste container/vessel 225 is controlled by venting vapor through conduit 250. Waste container 225 is typically operated at a pressure ranging from about 1 psig to 100 psig. The pressure in waste container 225 is typically lower than the pressure in vaporization vessel 40, thereby enabling flow to the waste container 225. When the waste container 225 is filled or becomes nearly filled with liquid, it may be returned to the low vapor pressure gas manufacturer for further processing. Alternatively, the contaminated liquid may be recycled to first containment vessel 10, or optionally routed via conduit 230 to the ultimate manufacturer's waste treatment system (not shown).

The low vapor pressure stream withdrawn from the vaporization vessel 40, may be further purified by routing the vapor through an adsorption, filtration or distillation device 290 disposed upstream of the delivery panel 70. The aforementioned purification device may include, for example, a partial condenser 290 which is cooled by a refrigerant stream to condense contaminants that are less volatile than ammonia. The refrigeration stream may include any of the commercially available refrigerants or may be provided by evaporation of the waste stream exiting waste container 225, via conduit 240. Optionally, partial condenser 290, can be incorporated as part of the vaporization vessel 40. Vapor exiting the partial condenser 290 is routed to the delivery panel 70, while the liquid component in the partial condenser is returned to the vaporization vessel 40. Alternatively, the vapor exiting the vaporization vessel 40 can be routed to a mist eliminator (not shown) to remove any liquid phase component and return it to the vaporization vessel.

Additional purification systems 210, such as filters, can be disposed downstream of the delivery panel to ensure that the low vapor pressure stream lean in low volatility contaminants is further purified prior to its delivery to the point of use.

While the invention has been described in detail with reference to specific embodiments thereof, it will become apparent to one skilled in the art that various changes and modifications can be made, and equivalents employed, without departing from the scope of the appended claims.

What is claimed is:

1. A system for transporting a low vapor pressure fluid and manufacturing a low vapor pressure stream containing primarily vapor, wherein the stream containing primarily vapor is lean in low volatility contaminants, and delivering the stream containing primarily vapor to a point of use, comprising:
providing a transport vessel having a liquid phase or two-phase low vapor pressure fluid contained therein;
transferring a portion of the liquid and/or two-phase low vapor pressure fluid from said transport vessel to a vaporization vessel, wherein at least part of the liquid is vaporized;
withdrawing a stream containing primarily liquid that is enriched in low volatility contaminants from the vaporization vessel; and
withdrawing a stream containing primarily vapor that is lean in low volatility contaminants from the vaporization vessel and delivering the stream containing primarily vapor to a point of use wherein the low volatility contaminant level of the stream containing primarily vapor is maintained within a desired range.

2. The system for manufacturing a low vapor pressure stream containing primarily vapor according to claim 1, further comprising:
pressurizing the transport vessel through injection of a high pressure inert gas therein to transfer the liquid and/or two-phase fluid to the vaporization vessel.

3. The system for manufacturing a low vapor pressure stream containing primarily vapor according to claim 1, further comprising: withdrawing the liquid phase or two-phase stream from the vaporization vessel in a batchwise or discontinuous manner.

4. The system for manufacturing a low vapor pressure stream containing primarily vapor according to claim 1, further comprising:
directing the vapor withdrawn from the vaporization vessel to a delivery panel which controls the flow rate, pressure and temperature of the low vapor pressure vapor stream delivered to the point-of-use.

5. The system for manufacturing a low vapor pressure stream containing primarily vapor according to claim 1, wherein the point-of-use is a semiconductor, LED or LCD manufacturing tool.

6. The system for manufacturing a low vapor pressure stream containing primarily vapor according to claim 1, further comprising:
pressurizing the transport vessel via a small amount of energy administered thereto.

7. The system for manufacturing a low vapor pressure stream containing primarily vapor according to claim 1, further comprising:
heating the liquid contained in the vaporization vessel via a heat exchanger in which the liquid is boiled against a second liquid fluid.

8. The system for manufacturing a low vapor pressure stream containing primarily vapor according to claim 1, wherein the liquid phase or two-phase fluid is a non-air based fluid selected from the group consisting of ammonia, hydrogen chloride, carbon dioxide, dichlorosilane, or a mixture thereof.

9. The system for manufacturing a low vapor pressure stream containing primarily vapor according to claim 1, wherein the liquid level in the vaporization vessel is maintained within a range of about 1 percent to 95 percent of the vessel height.

10. The system for manufacturing a low vapor pressure stream containing primarily vapor according to claim 1, wherein the flow rate of the low vapor pressure stream containing primarily vapor withdrawn from the vaporization vessel ranges from about 10 slpm to 2,000 slpm.

11. The system for manufacturing a low vapor pressure stream containing primarily vapor according to claim 1, wherein the pressure in said vaporization vessel ranges from about 50 psig to 300 psig, and the temperature ranges from about 32° F. to 125° F.

12. The system for manufacturing a low vapor pressure stream containing primarily vapor according to claim 1, further comprising:
purifying the low vapor pressure stream containing primarily vapor withdrawn from the second containment vessel in a further purification unit.

13. The system for manufacturing a low vapor pressure stream containing primarily vapor according to claim 12, further comprising:
routing the low vapor pressure stream containing primarily vapor withdrawn from the vaporization vessel through a partial condensation device disposed upstream of the purification unit.

14. The system for manufacturing a low vapor pressure stream containing primarily vapor according to claim 1, further comprising
routing the liquid stream withdrawn from the vaporization vessel to a waste container.

15. The system for manufacturing a low vapor pressure stream containing primarily vapor according to claim 14, further comprising:
maintaining the pressure within the waste container in a range of about 1 psig to 100 psig.

16. The system for manufacturing a low vapor pressure stream containing primarily vapor according to claim 14, further comprising:
recycling the liquid stream from the waste container to the transport vessel.

17. The system for manufacturing a low vapor pressure stream containing primarily vapor according to claim 16, further comprising:
scrubbing the liquid stream recycled prior to its introduction into the transport vessel.

18. The system for manufacturing a low vapor pressure stream containing primarily vapor according to claim 1, further comprising:
adjusting the rate at which the liquid stream is withdrawn from said vaporization vessel to maintain a desired purity.

19. The system for manufacturing a low vapor pressure stream containing primarily vapor according to claim 1, wherein the ratio of the flow of the stream containing primarily liquid to the flow of the stream containing primarily vapor is maintained at a near constant level.

20. The system for manufacturing a low vapor pressure stream containing primarily vapor according to claim 1, wherein the flow rate of the stream containing primarily liquid withdrawn from the vaporization vessel is adjusted based on the measured contaminant level in the stream containing primarily vapor exiting the vaporization vessel.

21. The apparatus for manufacturing a low vapor pressure stream containing primarily vapor, wherein the stream containing primarily vapor is lean in low volatile contaminants, comprising:
a transport vessel having a liquid phase or two-phase fluid therein;
a vaporization vessel, to which the liquid phase or two-phase fluid is transferred and at least partially vaporized;
means for controlling the energy delivered to said vaporization vessel;
a first conduit connected to a lower part of the vaporization vessel through which a stream containing primarily liquid enriched in low volatile contaminants is withdrawn; and a
a delivery panel connected via a second conduit to an upper part of the vaporization vessel through which a low vapor pressure stream containing primarily vapor is withdrawn and routed to a point of use, wherein the purity of the low vapor pressure stream containing primarily vapor is maintained within a desired range.

22. The apparatus for manufacturing a low vapor pressure stream containing primarily vapor according to claim 21, further comprising:
a supply of high pressure inert gas introduced into the transport vessel through pressurized injection to transfer the liquid phase or two-phase fluid to the vaporization vessel.

23. The apparatus for manufacturing a low vapor pressure stream containing primarily vapor according to claim 21, wherein the delivery panel controls the flow rate, pressure and temperature of the low vapor pressure stream containing primarily vapor delivered to the point of use.

24. The apparatus for manufacturing a low vapor pressure stream containing primarily vapor according to claim 21, wherein the transport vessel is an isotainer.

25. The apparatus for manufacturing a low vapor pressure stream containing primarily vapor according to claim 21, further comprising means for pressurizing the transport vessel.

26. The apparatus for manufacturing a low vapor pressure stream containing primarily vapor according to claim 21, further comprising:
a heater disposed in communication with the vaporization vessel.

27. The apparatus for manufacturing a low vapor pressure stream containing primarily vapor according to claim 21, further comprising:
a further purification unit disposed upstream of the point of use, to further remove contaminants from the low vapor pressure vapor stream.

28. The apparatus for manufacturing a low vapor pressure vapor stream according to claim 27, wherein the purification unit is a partial condensation device.

29. The apparatus for manufacturing a low vapor pressure stream containing primarily vapor according to claim 21, further comprising a waste container where the stream containing primarily liquid withdrawn from the vaporization vessel is directed.

30. The apparatus for manufacturing a low vapor pressure stream containing primarily vapor according to claim 29, further comprising:
a recyling loop returning the stream containing primarily liquid from the waste container to the transport vessel.

31. The apparatus for manufacturing a low vapor pressure stream containing primarily vapor according to claim, 30 further having a scrubber on the recycling loop disposed downstream of the waste container.
